(19) United States
(12) Patent Application Publication
(10) Pub. No.: US 2011/0063597 A1
(43) Pub. Date: Mar. 17, 2011

(54) OPTICAL SYSTEM FOR A MICROLITHOGRAPHIC PROJECTION EXPOSURE APPARATUS AND MICROLITHOGRAPHIC EXPOSURE METHOD

(75) Inventor: Markus Mengel, Heidenheim (DE)

(73) Assignee: CARL ZEISS SMT AG, Oberkochen (DE)

(21) Appl. No.: 12/851,074

(22) Filed: Aug. 5, 2010

Related U.S. Application Data
(63) Continuation of application No. PCT/EP2009/000854, filed on Feb. 6, 2009.
(60) Provisional application No. 61/028,928, filed on Feb. 15, 2008.

(30) Foreign Application Priority Data
Feb. 15, 2008 (DE) 10 2008 009 601.6

(51) Int. Cl. G03B 27/54; G02B 27/28; G02B 26/00

(52) U.S. Cl. 355/71; 359/483.01; 359/290

(57) ABSTRACT

An optical system for a microlithographic projection exposure apparatus, and a microlithographic exposure method are disclosed. An optical system for a microlithographic projection exposure apparatus includes an illumination device, which has a mirror arrangement having a plurality of mirror elements which are adjustable independently of one another for altering an angular distribution of the light reflected by the mirror arrangement, and at least one polarization state altering device like, e.g., a photoelastic modulator.

### CROSS-REFERENCE TO RELATED APPLICATIONS

This application is a continuation of, and claims benefit under 35 USC 120 to, international application PCT/EP2009/000854, filed Feb. 6, 2009, which claims benefit of German Application No. 10 2008 009 601.6, filed Feb. 15, 2008 and U.S. Ser. No. 61/028,928, filed Feb. 15, 2008. International application PCT/EP2009/000854 is hereby incorporated by reference in its entirety.

### FIELD

The disclosure relates to an optical system for a microlithographic projection exposure apparatus, and to a microlithographic exposure method.

### BACKGROUND

Microlithographic projection exposure apparatuses are used for the production of microstructured components such as, for example, integrated circuits or LCDs. Such a projection exposure apparatus has an illumination device and a projection objective. In the microlithography process, the image of a mask (=reticle) illuminated with the aid of the illumination device is projected, via the projection objective, onto a substrate (e.g. a silicon wafer) that is coated with a light-sensitive layer (photoresist) and is arranged in the image plane of the projection objective, in order to transfer the mask structure to the light-sensitive coating of the substrate.

US 2004/0262500 A1 discloses a method and an apparatus for the image-resolved polarimetry of a beam pencil generated by a pulsed radiation source (e.g., an excimer laser), e.g., of a microlithographic projection exposure apparatus, wherein two photoelastic modulators (PEM) that are excited at different oscillation frequencies and a polarization element e.g. in the form of a polarization beam splitter are positioned in the beam path, the radiation source is driven for emission of radiation pulses in a manner dependent on the oscillation state of the first and/or the second PEM, and the radiation coming from the polarization element is detected in image-resolved fashion via a detector.

The abovementioned photoelastic modulators (PEM) are optical components which are produced from a material exhibiting stress birefringence in such a way that an excitation of the PEM to effect acoustic oscillations leads to a periodically varying mechanical stress and thus to a temporally varying retardation. “Retardation” denotes the difference in the optical paths of two orthogonal (mutually perpendicular) polarization states. Photoelastic modulators (PEM) of this type are known in the prior art, e.g., U.S. Pat. No. 5,886,810 A1 or U.S. Pat. No. 5,744,721 A1, and can be produced and sold for use at wavelengths of visible light through to the VUV range (approximately 130 nm), e.g., by the company Hinds Instruments Inc., Hillsboro, Oreg. (USA).

In the operation of a microlithographic projection exposure apparatus it is often desirable to set defined illumination settings, that is to say intensity distributions in a pupil plane of the illumination device, in a targeted manner. Apart from the use of diffractive optical elements (so-called DOEs), the use of mirror arrangements is also known for this purpose, e.g., from WO 2005/026843 A2. Such mirror arrangements include a multiplicity of micromirrors that can be set independently of one another.

EP 1 879 071 A2 discloses an illumination optical unit for a microlithographic projection exposure apparatus which has two separate optical assemblies which are different from one another for setting at least two different illumination settings or for rapidly changing between such illumination settings, a coupling-out element being arranged in the light path upstream of the assemblies and a coupling-in element being arranged in the light path downstream of the assemblies. In this case, the coupling-out element can also have a plurality of individual mirrors arranged on a rotationally drivable mirror carrier, in which case, with the mirror carrier rotating, the illumination light is either reflected by one of the individual mirrors or transmitted between the individual mirrors.

### SUMMARY

The disclosure provides an optical system for a microlithographic projection exposure apparatus and a microlithographic exposure method by which an increased flexibility is afforded with regard to the intensity and polarization distributions that can be set in the projection exposure apparatus.

An optical system according to the disclosure for a microlithographic projection exposure apparatus includes:
an illumination device, which has a mirror arrangement having a plurality of mirror elements which are adjustable independently of one another for altering an angular distribution of the light reflected by the mirror arrangement; and
at least one polarization state altering device.

The polarization state altering device includes at least one element out of the group of photoelastic modulator, Pockels cell, Kerr cell, and rotatable polarization-changing plate. A polarization-changing plate is described in WO 2005/069081. Such plate acts as a polarization state altering device when it is rotated about an axis, e.g. about any symmetry axis. Fast polarization altering devices with switching or altering times down to 1 ns are Pockels or Kerr cells which are known per se from laser physics.

The photoelastic modulator can be subjected to a temporally varying retardation via suitable (e.g. acoustic) excitation in a manner known per se, which retardation may in turn be temporally correlated with the pulsed light, such that individual (e.g. successive) pulses of the pulsed light are subjected in each case to a defined retardation and hence to a defined alteration of their polarization state. This alteration can also be set differently for individual pulses. According to the present disclosure the photoelastic modulator also includes acoustic-optical modulators in which not necessarily standing waves of density variations are generated within the modulator material. Also the other exemplary polarization state altering devices mentioned above can be synchronized or correlated accordingly with the light pulses.

On account of the combination according to the disclosure of a polarization state altering device like, e.g., the photoelastic modulator firstly with a mirror arrangement having a plurality of mirror elements that are adjustable independently of one another, secondly, the possibility is afforded, combined with a changeover of the polarization state that is achieved via the polarization state altering device like, e.g., the photoelastic modulator, of performing an adjustment of the mirror elements that is coordinated therewith precisely such that, via the mirror arrangement, the entire light entering into the illumination device is directed, in a manner dependent on the polarization state currently set by the polarization state altering device like, e.g., the photoelastic modulator, into a region of the pupil plane which is in each case “appropriate” or suitable for generating a polarized illumination setting respectively sought, in which case, in particular, loss of light can be substantially or completely avoided.

In this case, the use of a polarization state altering device like a photoelastic modulator, a Pockels cell or a Kerr cell for generating an (in particular pulse-resolved) variation of the polarization state has the further advantage that the use of movable (e.g. rotating) optical components can be dispensed with, thereby also avoiding a stress birefringence that is induced in such components on account of e.g. centrifugal forces that occur, and an undesirable influencing of the polarization distribution that accompanies the stress birefringence.

In accordance with one embodiment, the polarization state altering device like, e.g., the photoelastic modulator is arranged upstream of the mirror arrangement in the light propagation direction.

In accordance with one embodiment, at least two illumination settings which are different from one another can be set by the alteration of an angular distribution of the light reflected by the mirror arrangement and/or by variation of the retardation generated in the polarization state altering device like, e.g., the photoelastic modulator. In this case, polarization state altering device like, e.g., photoelastic modulator and mirror arrangement can be operated in particular independently of one another, such that the alteration of an angular distribution of the light reflected by the mirror arrangement can be set independently of a polarization state of the light that is set by the polarization state altering device like e.g. the photoelastic modulator.

In accordance with one embodiment, provision is made of a driving unit for driving an adjustment of mirror elements of the mirror arrangement, the adjustment being temporally correlated with the excitation of the photoelastic modulator to effect mechanical oscillations.

In accordance with one embodiment, over all of the illumination settings that can be set, the ratio of the total intensity of the light contributing to the respective illumination setting to the intensity of the light entering into the photoelastic modulator varies by less than 20%, particularly less than 10%, more particularly less than 5%. In accordance with another approach, also upon variation of the illumination setting over all of the illumination settings that can be set, a wafer arranged in the wafer plane of the projection exposure apparatus is exposed with an intensity that varies by less than 20%.

In accordance with one embodiment, for each of the illumination settings that can be set, the total intensity of the light contributing to the respective illumination setting is at least 80%, particularly at least 90%, more particularly at least 95%, of the intensity of the light upon entering into the photoelastic modulator. This consideration disregards intensity losses owing to the presence of optical elements which do not contribute to the variation of the illumination setting, that is to say to the change of the angular distribution and/or of the polarization state, and can occur in particular between the photoelastic modulator and the mirror arrangement, such that for example intensity losses owing to absorption in lens materials are disregarded in this consideration.

In accordance with a further aspect, the disclosure relates to an optical system for a microlithographic projection exposure apparatus, including:
an illumination device;
a device which enables the polarization state of light passing through the optical system to be altered; and
a device which enables the angular distribution of light passing through the optical system to be altered;
wherein illumination settings which are different from one another can be set in the illumination device, at least two illumination settings of which differ in terms of the polarization state; and
wherein a change between the illumination settings can be carried out without exchanging one or more optical elements of the illumination device.

In this case, illumination settings that are regarded as differing from one another in terms of their polarization state include both illumination settings for which identical regions of the pupil plane are illuminated with light of different polarization states and illumination settings for which light of different polarization states is directed into mutually different regions of the pupil plane.

Furthermore, the wording “without exchanging one or more optical elements” should be understood to mean that all the optical elements remain in the beam path both during the exposure and between the exposure steps, in particular no additional elements being introduced into the beam path either.

The disclosure furthermore relates to a microlithographic exposure method.

Further configurations of the disclosure can be obtained from the description and the claims.

### BRIEF DESCRIPTION OF THE DRAWINGS

The disclosure is explained in more detail below on the basis of exemplary embodiments illustrated in the accompanying figures, in which:

FIG. 1 shows a schematic illustration for elucidating the construction of an optical system according to the disclosure of a projection exposure apparatus;

FIG. 2 shows an illustration for elucidating the construction of a mirror arrangement used in the illumination device from FIG. 1; and

FIGS. 3a-6b show exemplary illumination settings that can be set using an optical system according to the disclosure.

### DETAILED DESCRIPTION

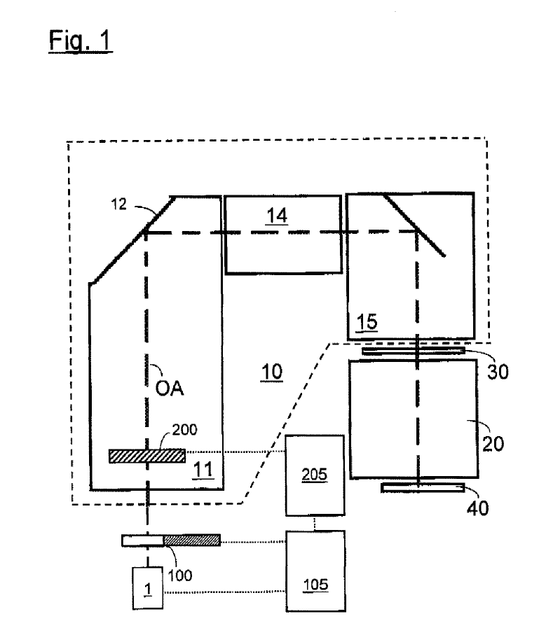

Firstly, with reference to FIG. 1, an explanation is given below of a basic construction of a microlithographic projection exposure apparatus including an optical system according to the disclosure including an illumination device 10 and a projection objective 20. The illumination device 10 serves for illuminating a structure-bearing mask (reticle) 30 with light from a light source unit 1, which includes for example an ArF excimer laser for an operating wavelength of 193 nm and a beam shaping optical unit that generates a parallel light beam.

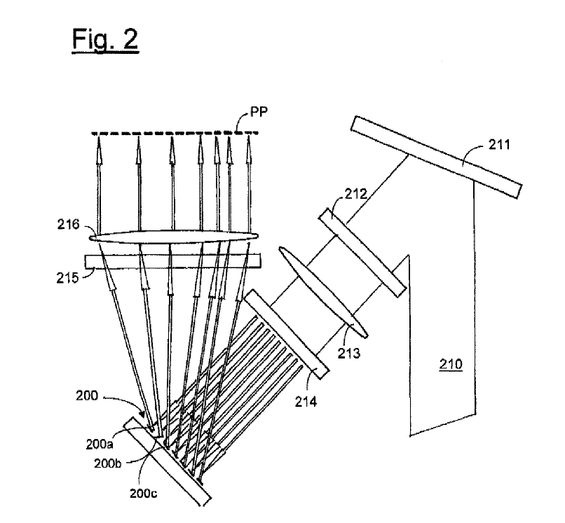

According to the disclosure, part of the illumination device 10 is, in particular, a mirror arrangement 200, as is explained in more detail below with reference to FIG. 2. Furthermore, arranged between the light source unit 1 and the illumination device 10 is a polarization state altering device 100, e.g., a photoelastic modulator (PEM), as is likewise explained in even further detail below. The illumination device 10 has an optical unit 11, which includes a deflection mirror 12, inter alia, in the example illustrated. Situated in the beam path in the light propagation direction downstream of the optical unit 11 are a light mixing device (not illustrated), which may have in a manner known per se, for example, an arrangement of micro-optical elements that is suitable for achieving a light mixing, and also a lens group 14, behind which is situated a field plane with a reticle masking system (REMA), which is imaged by a REMA objective 15 disposed downstream in the light propagation direction onto the structure-bearing mask (reticle) 30, which is arranged in a further field plane, and thereby delimits the illuminated region on the reticle. The structure-bearing mask 30 is imaged via the projection objective 20 onto a substrate 40, or a wafer, provided with a light-sensitive layer.

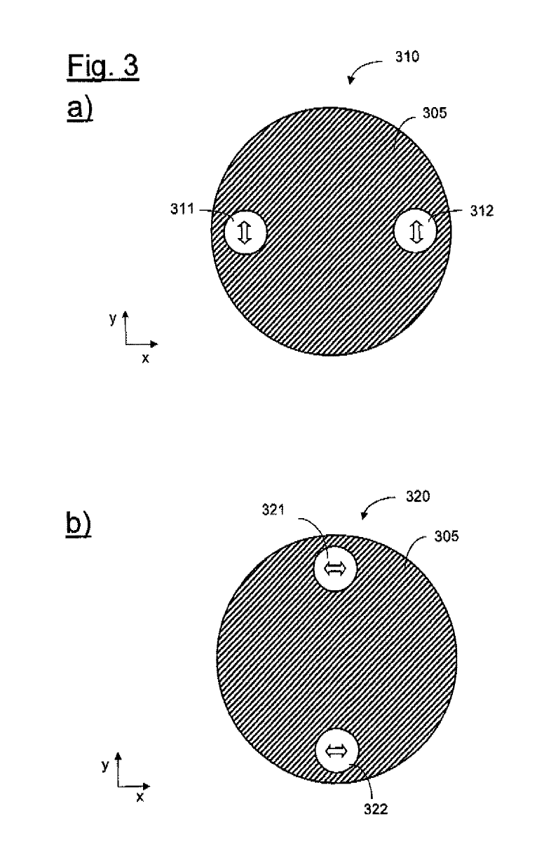

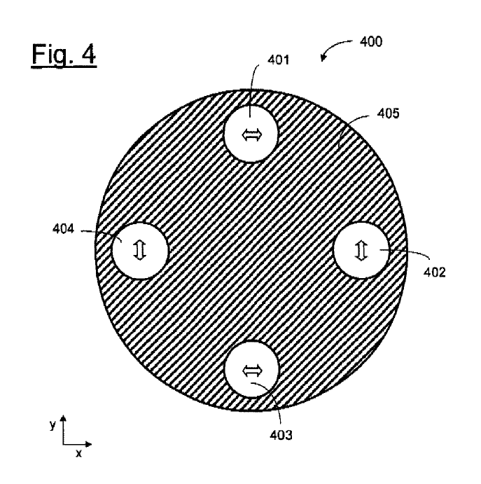

A polarization state altering device could be at least one element out of the group of photoelastic modulator, Pockels cell, Kerr cell, and rotatable polarization-changing plate. A polarization-changing plate is described in WO 2005/069081, e.g., in FIGS. 3 and 4. Such or a similar polarization-changing plate acts as a polarization state altering device when it is rotated about an axis, such as any symmetry axis. Fast polarization altering devices with switching or altering times down to about 1 ns or even less than 1 ns are Pockels cells or Kerr cells which are known per se from laser physics.

In the following detailed description of the disclosure the effect of the polarization state altering device is described by the example of a photolelastic modulator, which alters the polarization state according to the pressure performed on the photoelastic modulator, or more general, according to any force subjecting shear, strain or distension to at least parts of the material of the photoelastic modulator.

For the example of a Pockels cell as a polarization state altering device an electric field is applied at the Pockels cell. For the example of a Kerr cell a magnetic field or an electric field is used. Any other polarization state altering device based on an electro-optical principle (based e.g. on Pockels- and/or Stark-effect) and/or magneto-optical principle (based e.g. on Faraday and/or Cotton-Mouton-effect) can be used.

For the example of a polarization-changing plate as described in WO 2005/069081 there is no need for an external electric or magnetic field, pressure or force acting on the optical element to achieve the polarization altering effect. In this case the polarization altering effect is achieved by a rotation of the polarization-changing plate.

The illumination settings and the advantages as described below with the example of a photoelastic modulator acting as a polarization state altering device can also be achieved by using the other above mentioned polarization state altering devices. Therefore the embodiments described below are not limited to the operation of a photoelastic modulator only. Also a combination of several of the above mentioned polarization state altering devices parallel or in sequence according to the light beam path can be used to achieve the illumination settings and the advantages mentioned below.

The PEM 100 as one example of a polarization state altering device 100 in FIG. 1 can be excited to effect acoustic oscillations via an excitation unit 105 in a manner known per se, which leads to a variation—dependent on the modulation frequency—of the retardation generated in the PEM 100. The modulation frequency is dependent on the mechanical dimensioning of the PEM 100 and may typically be in the region of a few 10 kHz. It is assumed in FIG. 1, then, that the pressure direction or the oscillation direction is arranged at an angle of 45° relative to the polarization direction of the laser light that is emitted by the light source unit 1 and impinges on the PEM 100. The excitation of the PEM 100 by the excitation unit 105 is correlated with the emission from the light source unit 1 via suitable trigger electronics.

In accordance with FIG. 1, the illumination device 10 of the microlithographic projection exposure apparatus, having the mirror arrangement 200, is situated in the light propagation direction downstream of the photoelastic modulator (PEM) 100. In the construction illustrated schematically in FIG. 2, the mirror arrangement has a plurality of mirror elements 200a, 200b, 200c, . . . . The mirror elements 200a, 200b, 200c, . . . are adjustable independently of one another for altering an angular distribution of the light reflected by the mirror arrangement 200, in which case provision may be made of a driving unit 205 for driving this adjustment (e.g. via suitable actuators).

FIG. 2 shows, for elucidating the construction and function of the mirror arrangement 200 used in the illumination device 10 according to the disclosure, an exemplary construction of a partial region of the illumination device 10, including successively in the beam path of a laser beam 210 a deflection mirror 211, a refractive optical element (ROE) 212, a (depicted only by way of example) lens 213, a microlens arrangement 214, the mirror arrangement 200 according to the disclosure, a diffuser 215, a lens 216 and the pupil plane PP. The mirror arrangement 200 includes a multiplicity of micromirrors 200a, 200b, 200c, . . . , and the microlens arrangement 214 has a multiplicity of microlenses for targeted focusing onto the micromirrors and for reducing or avoiding an illumination of “dead area”. The micromirrors 200a, 200b, 200c, . . . can in each case be tilted individually, e.g. in an angular range of −2° to +2°, particularly −5° to +5°, more particularly −10° to +10°. Via a suitable tilting arrangement of the micromirrors 200a, 200b, 200c, . . . in the mirror arrangement 200, a desired light distribution, e.g. as explained in even further detail below an annular illumination setting or else a dipole setting or a quadrupole setting, can be formed in the pupil plane PP by the previously homogenized and collimated laser light being directed in the corresponding direction in each case by the micromirrors 200a, 200b, 200c, . . . , depending on the desired illumination setting.

For elucidating the interaction according to the disclosure of the PEM 100 with the mirror arrangement 200 situated in the illumination device 10, firstly a description is given hereinafter of how an “electronic switch-over” of the polarization state of light passing through the PEM 100 can be achieved by the PEM 100.

The light source unit 1 can generate for example a pulse at a point in time at which the retardation in the PEM 100 is precisely zero. Furthermore, the light source unit 1 can also generate a pulse at a point in time at which the retardation in the PEM 100 amounts to half the operating wavelength, that is to say λ/2. The PEM 100 therefore acts on the latter pulse as a lambda/2 plate, such that the polarization direction of the pulse upon emerging from the PEM 100 is rotated by 90° with respect to its polarization direction upon entering into the PEM 100. Depending on the instantaneous retardation value set in the PEM 100, in the example described the PEM 100 therefore either leaves the polarization direction of the light impinging on the PEM 100 unchanged or it rotates the polarization direction by an angle of 90°.

The PEM 100 is typically operated with a frequency of a few 10 kHz, such that the period duration of the excited oscillation of the PEM 100 is long in comparison with the pulse duration of the light source unit 1, which may typically be approximately 10 nanoseconds. Consequently, a quasi-static retardation acts on the light from the light source unit 1 in the PEM 100 during the duration of an individual pulse. Furthermore, the above-described variation of the polarization state set by the PEM 100 can be effected on the timescale of the pulse duration of frequency of the light source unit 1, that is to say that the changeover of the polarization state e.g. via rotation of the polarization direction by 90° can be performed in a targeted manner for specific pulses, in particular also between directly successive pulses from the light source unit 1. In the example described above, the two pulses described are oriented orthogonally with respect to one another in terms of their polarization direction when emerging from the PEM 100.

What can be achieved, then, through suitable adjustment of the mirror elements 200a, 200b, 200c, . . . that is coordinated with the above-described changeover of the polarization state is that the entire light entering into the illumination device 10 is directed by the mirror arrangement 200 into a respectively different region of the pupil plane that respectively “matches” the polarized illumination setting sought, in which case, in particular, loss of light can be substantially or completely avoided. In this case, in order to achieve a switch-over between the corresponding illumination settings, the driving of the mirror elements 200a, 200b, 200c, . . . via the driving unit 205 can be suitably correlated temporally with the excitation of the PEM 100 via the excitation unit 105.

Furthermore, photoelastic modulator 100 and mirror arrangement 200 can also be operated independently of one another, such that the alteration of an angular distribution of the light reflected by the mirror arrangement can be set independently of a polarization state of the light that is set by the photoelastic modulator 100. In this case, for example, even with the setting of the mirror elements 200a, 200b, 200c, . . . remaining the same, only a change in the polarization state can be performed via the PEM 100. Furthermore, what can also be achieved through suitable coordination or triggering of the pulses from the light source unit 1 in a manner dependent on the excitation of the photoelastic modulator 100 is that the pulses emerging from the photoelastic modulator 100 each have the same polarization state, in which case a different deflection for different pulses can be set via the mirror arrangement.

For the description of concrete exemplary embodiments it is assumed below, without restricting the generality, that the light which impinges on the PEM 100 and is generated by the light source unit 1 is polarized linearly in the y-direction relative to the system of coordinates depicted in FIG. 1.

Referring to FIGS. 3a and 3b, then, it is possible, via the arrangement according to the disclosure, to choose or switch over for example flexibly between an illumination setting 310 (FIG. 3a), in the case of which, in the pupil plane PP, only the regions 311 and 312 lying opposite one another in the x-direction in the system of coordinates depicted (that is to say horizontally), the regions also being referred to as illumination poles, are illuminated and the light is polarized in the y-direction in the regions (this illumination setting 310 is also referred to as a “quasi-tangentially polarized H dipole illumination setting”), and an illumination setting 320 (FIG. 3b), in the case of which only the regions 321 and 322 or illumination poles of the pupil plane PP that lie opposite one another in the y-direction in the system of coordinates depicted (that is to say vertically) are illuminated and the light is polarized in the x-direction in the regions (this illumination setting 320 is also referred to as a “quasi-tangentially polarized V dipole illumination setting”).

In this case, a “tangential polarization distribution” is generally understood to mean a polarization distribution in the case of which the oscillation direction of the electric field strength vector runs perpendicular to the radius directed at the optical system axis. A “quasi-tangential polarization distribution” is the term correspondingly employed when the above condition is met approximately or for individual regions in the relevant plane (e.g. pupil plane), as for the regions 311, 312, 321 and 322 in the examples of FIGS. 3a-b.

In order to set the “quasi-tangentially polarized H dipole setting” from FIG. 3a, the PEM 100 is operated or driven such that it transmits the light impinging on it without changing the polarization direction, at the same time the mirror elements 200a, 200b, 200c, . . . of the mirror arrangement 200 being set in such a way that they deflect the entire light into the pupil plane PP exclusively onto the regions 311 and 312 lying opposite one another in the x-direction. In order to set the “quasi-tangentially polarized V dipole illumination setting” from FIG. 3b, the PEM 100 is operated or driven in such a way that it rotates the polarization direction of the light impinging on it by 90°, at the same time the mirror elements 200a, 200b, 200c, . . . of the mirror arrangement 200 being set in such a way that they deflect the entire light into the pupil plane PP exclusively onto the regions 321 and 322 lying opposite one another in the y-direction. The hatched region 305 in FIG. 3a and FIG. 3b corresponds in each case to that region in the pupil plane which is not illuminated but which can still be illuminated alongside the illuminated regions. A switch-over between the illumination settings described above can be achieved by corresponding coordination of the adjustment of the mirror elements 200a, 200b, 200c, . . . of the mirror arrangement 200 with the excitation of the PEM 100.

Furthermore, the arrangement according to the disclosure can also be used as follows for setting a quasi-tangentially polarized quadrupole illumination setting 400, as is illustrated in FIG. 4. For this purpose, during a time duration within which the PEM 100 transmits light impinging on it without changing the polarization direction, the mirror elements 200a, 200b, 200c, . . . of the mirror arrangement 200 can be set in such a way that they deflect the entire light into the pupil plane PP exclusively onto the regions 402 and 404 lying opposite one another in the x-direction in the system of coordinates depicted (that is to say horizontally). By contrast, during a time duration within which the PEM 100 rotates the polarization direction of the light impinging on it by 90°, the mirror elements 200a, 200b, 200c, . . . of the mirror arrangement 200 are set in such a way that they deflect the entire light into the pupil plane PP exclusively onto the regions 401 and 403 or illumination poles lying opposite one another in the y-direction in the system of coordinates depicted (that is to say vertically). A switch-over between the two illumination settings 310 and 320 from FIGS. 3a and 3b is achieved in this way. If the timescale of the switch-over between these illumination settings is then adapted to the duration of the exposure of a structure during the lithography process in such a way that the structure is illuminated with both illumination settings 310 and 320, the quasi-tangentially polarized quadrupole illumination setting 400 illustrated in FIG. 4 is effectively realized. The hatched region 405 once again corresponds to that region in the pupil plane which is not illuminated but which can still be illuminated alongside the illuminated regions.

The embodiments described above with reference to FIGS. 3a-b and FIG. 4 can also be modified in an analogous manner such that, instead of the respective quasi-tangentially polarized (dipole or quadrupole) illumination setting, a quasi-radially polarized (dipole or quadrupole) illumination setting is produced or a switch-over between such illumination settings is achieved by replacing the polarization directions indicated in FIGS. 3a-b and FIG. 4, respectively, by the polarization direction rotated by 90°. In this case, a “radial polarization distribution” is generally understood to mean a polarization distribution in the case of which the oscillation direction of the electric field strength vector runs parallel to the radius directed at the optical system axis. A “quasi-radial polarization distribution” is the term correspondingly employed when the above condition is met approximately or for individual regions in the relevant plane (e.g. pupil plane).

In accordance with further embodiments, the setting or excitation of the PEM 100 by the excitation unit 105 can be correlated with the emission from the light source unit 1 and the driving of the mirror arrangement 200 via the driving unit 205 in such a way that illumination settings with left and/or right circularly polarized light are produced or a switch-over between these illumination settings is realized. For this purpose, pulses can pass through the PEM 100 for example in each case at a point in time at which the retardation in the PEM 100 amounts to one quarter of the operating wavelength, that is to say λ/4 (which leads e.g. to left circularly polarized light). Furthermore, pulses can pass through the PEM 100 at a point in time at which the retardation in the PEM 100 is of identical magnitude and opposite sign, that is to say amounts to −λ/4, which leads to right circularly polarized light.

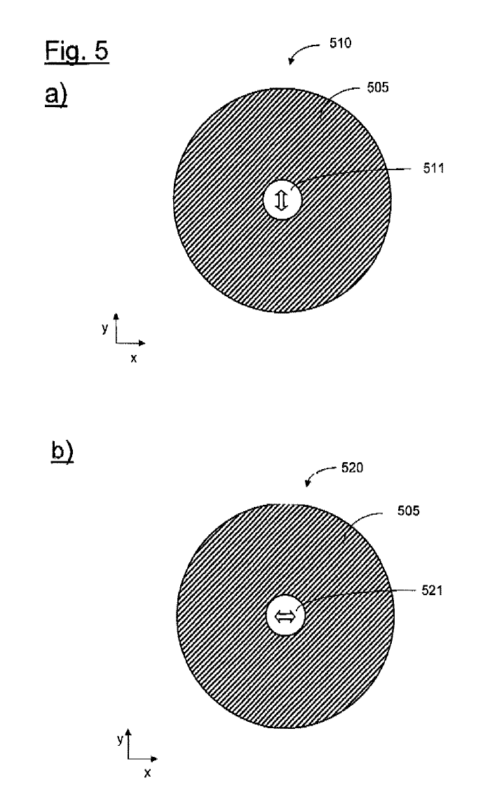

In accordance with further embodiments, the PEM 100 can also interact with the mirror arrangement 200 in such a way that an electronic switch-over is achieved between the illumination settings 510 and 520 shown in FIGS. 5a-b, in the case of which only a comparatively small region 511 and 521, respectively, in the center of the pupil plane PP is illuminated with linearly polarized light and which are also referred to as “V-polarized coherent illumination setting” (FIG. 5a) and “H-polarized coherent illumination setting” (FIG. 5b), depending on the polarization direction. These illumination settings are also referred to as conventional illumination settings. The hatched region 505 once again corresponds in each case to that region in the pupil plane which is not illuminated but which can still be illuminated alongside the illuminated regions, and can vary for different conventional illumination settings depending on the diameter of the illuminated region (that is to say depending on the fill factor having a value of between 0% and 100%).

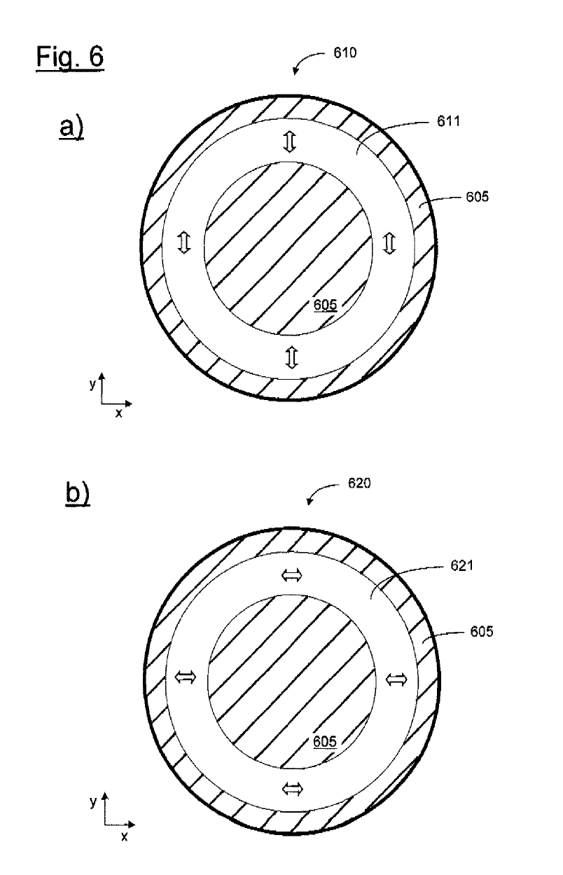

In accordance with further embodiments, the PEM 100 can also interact with the mirror arrangement 200 in such a way that an electronic switch-over is achieved between the illumination settings 610 and 620 shown in FIGS. 6a-b, in the case of which a ring-shaped region 611 and 621, respectively, of the pupil plane PP is illuminated with linearly polarized light and which are also referred to as “V-polarized annular illumination setting” (FIG. 6a) and “H-polarized annular illumination setting” (FIG. 6b), depending on the polarization direction.

The hatched region 605 once again corresponds to that region in the pupil plane which is not illuminated but which can still be illuminated alongside the illuminated regions. Even though the disclosure has been described on the basis of specific embodiments, numerous variations and alternative embodiments can be deduced by the person skilled in the art, e.g. by combination and/or exchange of features of individual embodiments. Accordingly, it goes without saying for the person skilled in the art that such variations and alternative embodiments are also encompassed by the present disclosure, and the scope of the disclosure is only restricted within the meaning of the accompanying patent claims and the equivalents thereof.

What is claimed is:

1. An optical system, comprising:
an illumination device comprising a mirror arrangement comprising a plurality of mirror elements which are adjustable independently from one another to alter an angular distribution of light reflected by the mirror arrangement during use; and
a polarization state altering device,
wherein the optical system is configured to be used in a microlithographic projection exposure apparatus.

2. The optical system as claimed in claim 1, wherein the polarization state altering device is upstream of the mirror arrangement in a propagation direction of the light during use.

3. The optical system as claimed in claim 1, wherein the polarization state altering device comprises at least one element selected from the group consisting of a photoelastic modulator, a Pockels cell, a Kerr cell and a rotatable polarization-changing plate.

4. The optical system as claimed in claim 1, wherein the polarization state altering device comprises a photoelastic modulator, and the system further comprises an excitation unit configured to excite the photoelastic modulator to effect mechanical oscillations to generate a temporally varying retardation in the photoelastic modulator.

5. The optical system as claimed in claim 4, wherein the temporally varying retardation generated in the photoelastic modulator has a modulation frequency of in the region of a few 10 kHz.

6. The optical system as claimed in claim 1, further comprising a light source configured to generate pulsed light.

7. The optical system as claimed in claim 6, wherein, during use, the polarization state of at least two pulses of the pulsed light are different from one another after emerging from the polarization state altering device.

8. The optical system as claimed in claim 7, wherein the at least two pulses have mutually orthogonal polarization states after emerging from the polarization state altering device.

9. The optical system as claimed in claim 8, wherein the mutually orthogonal polarization states are states of linear polarization with mutually perpendicular polarization directions.

10. The optical system as claimed in claim 8, wherein the mutually orthogonal polarization states are states of circular polarization with mutually opposite handedness.

11. The optical system as claimed in claim 1, wherein the optical system is configured so that alteration of an angular distribution of the light reflected by the mirror arrangement during use can be set independent of a polarization state of the light that is set by the polarization state altering device during use.

12. The optical system as claimed in claim 1, wherein at least two illumination settings, which are different from one another, can be set by altering an angular distribution of the light reflected by the mirror arrangement and/or by varying the retardation generated in the polarization state altering device.

13. The optical system as claimed in claim 12, wherein the at least two illumination settings differ in that identical regions of a pupil plane of the illumination device are illuminated with light of different polarization states.

14. The optical system as claimed in claim 12, wherein the at least two illumination settings differ in that different regions of a pupil plane of the illumination device are illuminated.

15. The optical system as claimed in claim 12, wherein at least one of the at least two illumination settings is selected from the group consisting an annular illumination setting, a dipole illumination setting, a quadrupole illumination setting, and a conventional illumination setting.

16. The optical system as claimed in claim 15, wherein the system is configured to that the at least two illumination settings can be set to any member selected from the group consisting an annular illumination setting, a dipole illumination setting, a quadrupole illumination setting, and a conventional illumination setting.

17. The optical system as claimed in claim 4, further comprising a driving unit configured to drive an adjustment of the plurality of mirror elements, the adjustment being temporally correlated with the excitation of the photoelastic modulator.

18. The optical system as claimed in claim 12, wherein the polarization state altering device comprises a photoelastic modulator, and, over all of the illumination settings that can be set, a ratio between a total intensity of the light contributing to a respective illumination setting and an intensity of the light entering into the photoelastic modulator varies by less than 20%.

19. The optical system as claimed in claim 12, wherein the polarization state altering device comprises a photoelastic modulator, and, for each of the illumination settings that can be set, a total intensity of the light contributing to a respective illumination setting is at least 80% of an intensity of the light upon entering into the photoelastic modulator.

20. An optical system, comprising:
an illumination device;
a first device configured to enable a polarization state of light passing through the optical system to be altered; and
a second device configured to enable an angular distribution of light passing through the optical system to be altered,
wherein:
illumination settings which are different from one another can be set in the illumination device during use;
at least two of the illumination settings have different polarization states;
over all of the illumination settings that can be set, a ratio of a total intensity of the light contributing to a respective illumination setting and an intensity of the light entering into the first device varies by less than 20%; and
the optical system is configured to be used in a microlithographic projection exposure apparatus.

21. The optical system as claimed in claim 20, wherein the ratio varies by less than 10% over all of the illumination settings that can be set.

22. The optical system as claimed in claim 20, wherein, during use, for each of the illumination settings that can be set, the total intensity of the light contributing to the respective illumination setting is at least 80% of the intensity of the light upon entering into the first device.

23. The optical system as claimed in claim 20, wherein a change between the illumination settings can be carried out without exchanging one or more elements of the illumination device.

24. The optical system as claimed in claim 20, wherein, during use, a modulation frequency of a retardation generated in the first device is in the region of a few 10 kHz.

25. An optical system, comprising:
an illumination device;
a first device configured to enable a polarization state of light passing through the optical system to be altered; and
a second device configured to enable an angular distribution of light passing through the optical system to be altered,
wherein:
illumination settings which are different from one another can be set in the illumination device during use;
at least two illumination settings have different polarization states;
a change between the illumination settings can be carried out without exchanging one or more optical elements of the illumination device; and
the optical system is configured to be used in a microlithographic projection exposure apparatus.

26. The optical system as claimed in claim 20, wherein the system is configured so that all of the following illumination settings can be set: an annular illumination setting, a dipole illumination setting, a quadrupole illumination setting, and a conventional illumination setting during use.

27. The optical system as claimed in claim 20, wherein the system is configured so that at least two different dipole illumination settings having mutually orthogonal polarization states can be set during use.

28. The optical system as claimed in claim 20, wherein the system is configured so that at least one illumination setting having an at least approximately tangential polarization distribution or an at least approximately radial polarization distribution can be set during use.
